(19) United States
(12) Patent Application Publication
(10) Pub. No.: US 2025/0182293 A1
(43) Pub. Date: Jun. 5, 2025

(54) IMAGE PROCESSING METHOD AND IMAGE PROCESSING DEVICE

(71) Applicant: MEDIATEK INC., Hsinchu City (TW)

(72) Inventors: Kuang-Hung Chien, Hsinchu City (TW); Yu-Chun Chen, Hsinchu City (TW); Yi-Chen Chen, Hsinchu City (TW); Sheng-Po Kuo, Hsinchu City (TW); Chia-Ping Chen, Hsinchu City (TW); Hui Ouyang, Hsinchu City (TW); Yu-Cheng Chu, Hsinchu City (TW)

(73) Assignee: MEDIATEK INC., Hsinchu City (TW)

(21) Appl. No.: 18/963,722

(22) Filed: Nov. 28, 2024

Related U.S. Application Data
(60) Provisional application No. 63/604,940, filed on Dec. 1, 2023.

(51) Int. Cl. G06T 7/13; G06T 3/40

(52) U.S. Cl. CPC G06T 7/13; G06T 3/40; G06T 2207/20192

(57) ABSTRACT

An image processing method, applied to an image processing device, comprising: (a) deciding a first reference size of at least one reference region of an input image based on a computational resource of the image processing device or task types of tasks which are being processed by the image processing device; and (b) processing at least portion of the input image based on the reference region to generate a processed image.

### CROSS REFERENCE TO RELATED APPLICATIONS

This application claims the benefit of U.S. Provisional Application No. 63/604,940, filed on Dec. 1, 2023. The content of the application is incorporated herein by reference.

### BACKGROUND

The present application relates to an image processing method and an image processing device, and particularly relates to an image processing method and an image processing device which can reduce area overhead (e.g., overlapped reference regions).

When processing images, such as dealing with complex video or image quality enhancement techniques, most related art have relied on lossless methods in order to achieve better performance (e.g., through tiling or pipeline techniques). However, such method often results in larger area overhead and higher computational resource requirements. Besides, most image enhancement only concerns the enhancement result but does not concerns the computational resource. Accordingly, the usage of the computational resource is not optimized and the performance of the image processing may be reduced.

### SUMMARY

One objective of the present application is to provide an image processing method which can dynamically adjust the area overhead and optimize the computational resource.

Another objective of the present application is to provide an image processing device which can dynamically adjust the area overhead and optimize the computational resource.

One embodiment of the present application discloses an image processing method, applied to an image processing device, comprising: (a) deciding a first reference size of at least one reference region of an input image based on a computational resource of the image processing device or task types of tasks which are being processed by the image processing device; and (b) processing at least portion of the input image based on the reference region to generate a processed image.

Another embodiment of the present application discloses an image processing device, comprising: a processing system, configured to perform following steps: (a) deciding a first reference size of at least one reference region of an input image based on a computational resource of the image processing device or task types of tasks which are being processed by the image processing device; and (b) processing at least portion of the input image based on the reference region to generate a processed image.

In view of above-mentioned embodiments, the area overhead may be dynamically adjusted corresponding to different requirements. By this way, the image quality of the output image may be remained without increasing too much computation. Also, the usage of the computation resource can be accordingly optimized.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A, FIG. 1B, FIG. 2A, FIG. 2B and FIG. 2C, FIG. 3 and FIG. 4 are schematic diagrams illustrating image processing methods according to different embodiments of the present application.

FIG. 5A and FIG. 5B are flow charts illustrating the image processing method, according to one embodiment of the present application.

FIG. 6 is a flow chart illustrating summarized steps of an image processing method according to one embodiment of the present application.

FIG. 7 is a flow chart illustrating summarized steps of an image processing method according to another embodiment of the present application.

FIG. 8 is a block diagram illustrating an image processing device according to one embodiment of the present application.

### DETAILED DESCRIPTION

Several embodiments are provided in following descriptions to explain the concept of the present invention. The method in following descriptions can be performed by programs stored in a non-transitory computer readable recording medium by a processing circuit. The non-transitory computer readable recording medium can be, for example, a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices. Further, the term “image” in following descriptions may mean a still image such as a picture, or an image in video data such as a video stream.

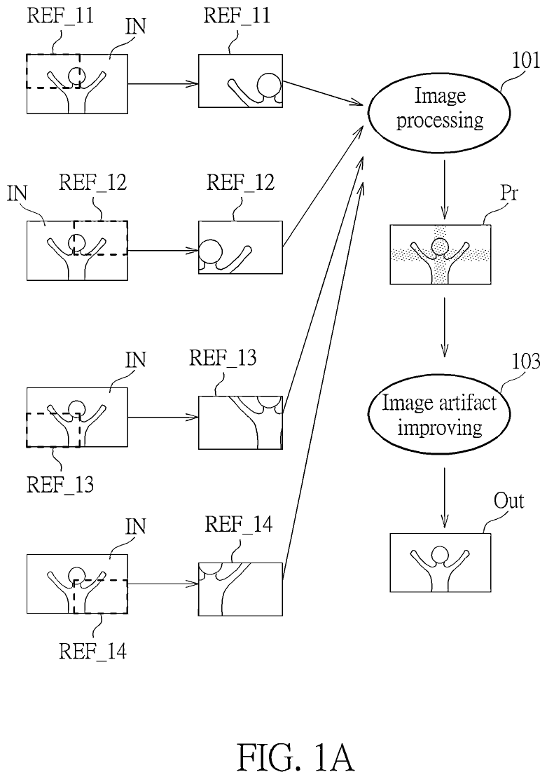

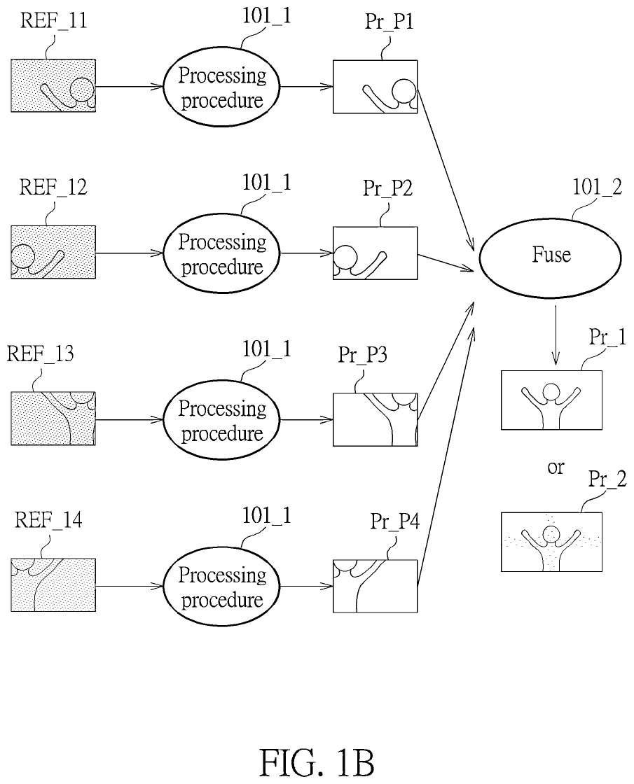

FIG. 1A, FIG. 1B, FIG. 2A, FIG. 2C, FIG. 3 and FIG. 4 are schematic diagrams illustrating image processing methods according to different embodiments of the present application. In the embodiment of FIG. 1A, the input image IN is defined as a plurality of reference regions respectively with a first reference size, wherein at least portion of the reference regions are overlapped. In the embodiment of FIG. 1A, the input image IN is defined as four reference regions REF_11, REF_12, REF_13 and REF_14. At least portion of the reference regions REF_11, REF_12, REF_13 and REF_14 is overlapped. However, the input image IN may be defined as any other number of reference regions.

After the input image IN has been defined, at least portion of the input image IN is processed based on the reference regions REF_11, REF_12, REF_13 and REF_14 to generate a processed image Pr via an image processing method 101. In one embodiment, the image processing method 101 is an image enhancement method, which enhances at least portion of the input image IN based on the reference regions REF_11, REF_12, REF_13 and REF_14. For example, in image convolution, a kernel is used to enhance the input image IN based on the reference regions REF_11, REF_12, REF_13 and REF_14. If the image processing method 101 is an image enhancement method, the image processing method 101 may further comprises a noise reduction method to enhance the input image IN.

In the embodiment of FIG. 1A, an image artifact improving method 103 is further provided to process the processed image Pr to generate an output image Out. The image artifact improving method 103 may be used to improve the image artifacts of the processed image Pr. In one embodiment, the reference regions REF_11, REF_12, REF_13 and REF_14 are respectively processed by the image processing method to generate a plurality of processed image portions. Then, the processed image portions are fused to generate the processed image Pr. However, edge artifacts may occur in some regions of the processed image Pr which correspond the edges of the processed image portions. In such case, the image artifact improving method 103 may be used to improve the edge artifacts, such as an image smooth method. Please note, the image artifact improving method 103 may also be used to improve other artifacts generated in the image processing method 101, rather than limited to the edge artifacts.

FIG. 1B is a schematic diagram illustrating details of the image processing method 101 and the reference regions REF_11, REF_12, REF_13 and REF_14, according to one embodiment of the present application. As shown in FIG. 1B, the image processing method 101 comprises a processing procedure 101_1 and a fuse step 101_2. The processing procedure 101_1 respectively generates processed image portions Pr_P1, Pr_P2, Pr_P3 and Pr_P4 according to the reference regions REF_11, REF_12, REF_13 and REF_14. Then, the processed image portions Pr_P1, Pr_P2, Pr_P3 and Pr_P4 are fused by the fuse step 101_2 to generate a processed image. The detail steps of the processing procedure 101_1 may be different corresponding to the contents of the image processing method 101. For example, if the image processing method 101 is the above-mentioned image enhancement method, the processing procedure 101_1 may comprise steps for enhancing images.

In the embodiment of FIG. 1B, the fuse step 101_2 further includes image artifact improvement using the overlapped regions of the reference regions. Accordingly, the fuse step 101_2 may generate a processed image Pr_1 which has no noticeable edge artifacts, or a processed image Pr_2 which has few edge artifacts. If the processed image Pr_1 without noticeable edge artifacts is generated, it can be directly used as the output image Out without performing the image artifact improving method 103, thus the image artifact improving method 103 can be removed in such example. If the processed image Pr_2 with few edge artifacts is generated, it may also be directly used as the output image Out if the edge artifacts are under a predetermined threshold. Alternatively, in one embodiment, the processed image Pr_2 may further be processed by the image artifact improving method 103 to generate the output image Out with less edge artifacts.

Some steps of FIG. 1B may also be used in the embodiment of FIG. 1A. As stated above, in the embodiment of FIG. 1A, the reference regions REF_11, REF_12, REF_13 and REF_14 are respectively processed by the image processing method 101 to generate a plurality of processed image portions. Then, the processed image portions are fused by the fuse step 101_2 to generate the processed image Pr. The reference regions REF_11, REF_12, REF_13 and REF_14 may be respectively processed by the processing procedure 101_1 in FIG. 1B to generate processed image portions Pr_P1, Pr_P2, Pr_P3 and Pr_P4, However, in such case, the fuse step 101_2 which fuses the processed image portions Pr_P1, Pr_P2, Pr_P3 and Pr_P4 does not include image artifact improvement using the overlapped regions.

In one embodiment, the parameters of the reference regions REF_11, REF_12, REF_13, REF_14, or the parameters of the image artifact improving method 103 may be set to ensure an image quality of the output image Out is higher than a quality threshold. The parameters of the reference regions REF_11, REF_12, REF_13 and REF_14 may be, for example, the locations or the sizes of the reference regions REF_11, REF_12, REF_13 and REF_14. The parameters of the image artifact improving method 103 may be, for example, the algorithm which is used for the image artifact improving method 103 or the image artifact improving intensity of the image artifact improving method 103.

If the overlapped regions (e.g., the above-mentioned area overhead) of the reference regions are larger, the image artifact can be better improved, but more computation is needed. Accordingly, the parameters of the reference regions REF_11, REF_12, REF_13 and REF_14 may be set in a balance manner, to consider a proper output image Out being generated (e.g., the image quality of the output image is higher than the quality threshold) and available computation resources. In some embodiments, the image quality refers to the image artifact due to the boundaries between the reference regions REF_11, REF_12, REF_13 and REF_14.

In one embodiment, the output image Out is compared with a reference image, and then the parameters of the reference regions REF_11, REF_12, REF_13, REF_14 and the parameters of the image artifact improving method 103 are set according to a difference between the output image Out and the reference image. The difference between the output image Out and the reference image may be computed according to various algorithms, such as MAE (masked auto encoders), MSE (Mean Squared Error), PSNR (Peak Signal-to-Noise), and SSIM (structural similarity index measure). The parameters of the reference regions REF_11, REF_12, REF_13 and REF_14 and the parameters of the image artifact improving method 103 may be periodically updated. In one embodiment, such method can be used to inference an image processing model, which is used to process the input image IN. An example of such method is illustrated in FIG. 2A and FIG. 2C.

In FIG. 2A, the input image IN is initially to be defined as a plurality of reference regions REF_21, REF_22, REF_23, REF_24 with a second reference size before the steps illustrated in FIG. 1A. Specifically, the input image IN is initially to be defined as a plurality of reference regions with a second reference size before defining the input image IN into the reference regions REF_11, REF_12, REF_13, REF_14 with the first reference sizes. The second reference size is larger than the first reference size. Accordingly, the overlapped regions of the reference regions with the second reference size are larger than the overlapped regions of the reference regions with the first reference size and can therefore better reduce the image artifact but require more computation resources. The overlapped regions in FIG. 2A, FIG. 2B and FIG. 2C are marked as dotted regions.

The defining of the reference regions REF_21, REF_22, REF_23, REF_24 may be achieved by various methods. In the embodiment of FIG. 2B, the input image In is first defined as four initial regions IR_11, IR_12, IR_13 and IR_14. The initial regions IR_11, IR_12, IR_13 and IR_14 have the same sizes, form the whole input IN and do not overlap. Afterwards, the required overlapped regions, which are marked as dotted regions are respectively added to the initial regions IR_11, IR_12, IR_13 and IR_14 to define the reference regions REF_21, REF_22, REF_23, REF_24. The defining of the reference regions in other embodiments may also follow such example, but not limited. Accordingly, changing of the reference sizes can be achieved by changing the sizes of the overlapped regions.

In one embodiment, before defining the input image IN to reference regions REF_21, REF_22, REF_23, REF_24, the second reference size is reduced to the first reference size, and then the input image IN is defined as the reference regions REF_11, REF_12, REF_13, REF_14 with first reference sizes, as shown in FIG. 2C. The change of the reference sizes may be based above-mentioned difference between the output image Out and the reference image. In such example, the reference sizes are the above-mentioned parameters of the reference regions stated in FIG. 1A.

In one embodiment, change of the reference sizes may be based a computational resource of the image processing device or task types of tasks which are being processed by the image processing device. In one embodiment, the computational resource comprises at least one of following resources: a storage capacity (e.g., a storage capacity of a dram or a flash), a storage device bandwidth (e.g., a bandwidth of a dram or a flash), a processing ability (e.g., a microprocessor performance) and a power consumption rate. The task types may be related with the operation of the image processing device. For example, if the image processing device is a mobile phone which is used for taking pictures, there are fewer images to be processed and the processing frequency is low, thus larger reference regions can be used. On the contrary, if the image processing device is a mobile phone which is used for playing a game, there are more images to be processed in a very short time, thus smaller reference regions are used.

In one embodiment, the reference regions with the second reference sizes may be used initially, and then change to use the first reference sizes, based on the computational resource or the task types.

Besides the reference region size, the number of the reference regions may also be changed based on the computational resource or the task types. As shown in FIG. 3, the input image IN is initially defined as a first number of the reference regions REF_11, REF_12, REF_13 and REF_14 and then changes to be defined as a second number of the reference regions REF_31, REF_32, REF_33, REF_34, REF_35 and REF_36 according to the system resources or the task types. The second number is larger than the first number. For example, as shown in FIG. 3, the first number is 6 and the second number is 4.

Portions of the reference regions REF_11, REF_12, REF_13 and REF_14 are overlapped, and portions of the reference regions REF_31, REF_32, REF_33, REF_34, REF_35 and REF_36 are overlapped. In one embodiment, the more the number of the reference regions, the smaller the necessary computational resource for each reference region is. If the necessary computational for each reference region is large, it will be difficult to allocate computational resource reasonably and flexibly. Accordingly, if the input image is defined as more reference regions, the computational resource may be efficiently allocated, and thereby the overall performance of t the image processing can be improved. The change of the first number and the second number may be performed before the image IN is defined as the first number of the reference regions, but may be performed after the image IN has been defined as the first number of the reference regions. Also, besides the computational resource or the task types, the numbers of the reference regions may be changed based on the difference of the output image Out and the reference image.

Besides defining the input image IN to a plurality of reference regions, the input image IN may be processed by other methods. In one embodiment, a processing region (e.g., first processing region PR_1 in FIG. 4), which comprises a target region (e.g., the target region TI in FIG. 4) of the input image IN and comprises the reference region (e.g., the first reference region REF_1 in FIG. 4) is defined. After that, the target region TI is processed according to the reference region. For example, the target region TI may be enlarged (e.g., zoom in) or being enhanced according to the reference region.

The size of the processing region can be changed, for example, according to the computational resource or the task types. In the embodiment of FIG. 4, a second processing region PR_2 is decided, which comprises the target region TI of the input image IN and the reference region REF_2. The second processing region PR_2 may be changed to a first processing region PR_1, which comprises the target region TI and the reference region. The second processing region PR_2 is larger than the first processing region PR_1, thus the reference region REF_2 is larger than the reference region REF_1. In other words, the second reference region REF_2 may have a second reference size and the first reference region REF_1 may have a first reference size smaller than the second reference size. In such embodiment, the above-mentioned area overhead may mean the sizes of the reference regions rather than the overlapped regions of the reference regions. The change of the processing region may occur before the target region TI is processed based on the second reference region REF_2 or after the target region TI has been processed based on the second reference region REF_2.

Please note, in the embodiment of FIG. 4, the processing region is changed from an initial processing region (e.g., from the processing region PR_2 to the processing region PR_1). However, the size of the processing region may be directly set rather than changing from an initial size.

As above-mentioned, the reference regions may be adjusted according to the computational resources to reduce the area overhead (e.g., the overlapped regions or the sizes of the reference regions). In one embodiment, the amount of area overhead reduction is related to the amount of the computational resource. For example, if the computational resource is constrained, more area overhead is reduced. On the contrary, if the computational resource is not constrained, less area overhead is reduced.

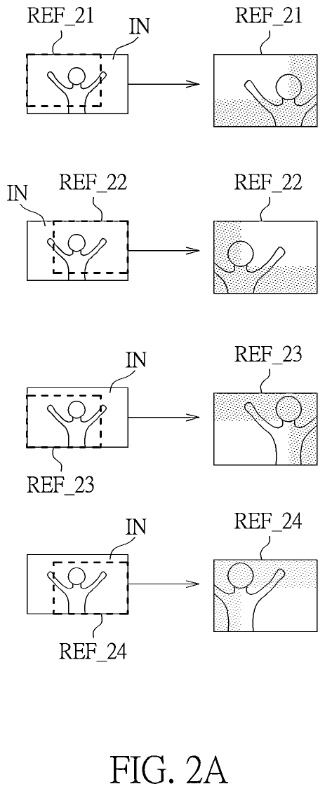

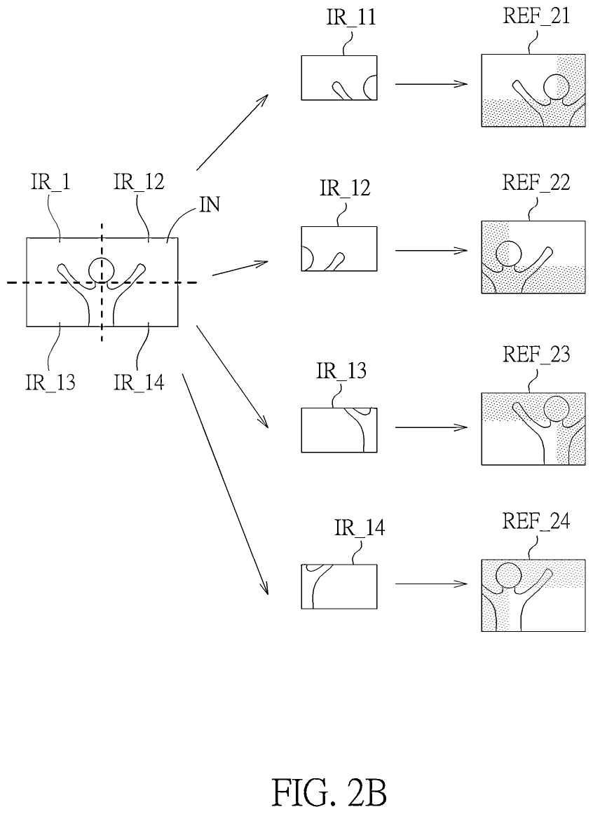

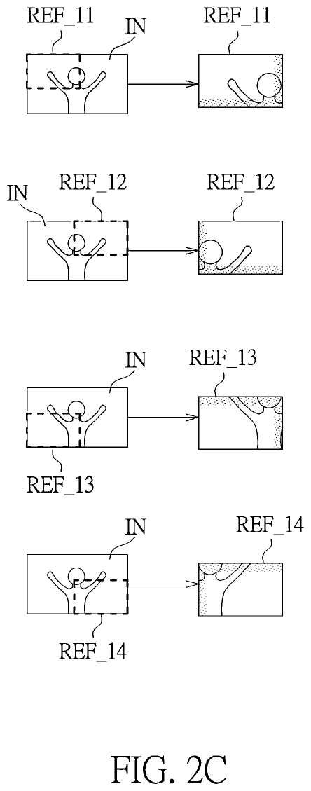

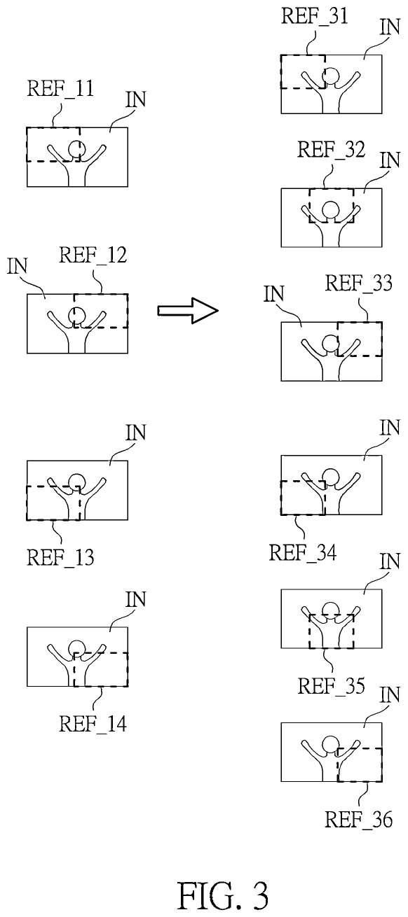

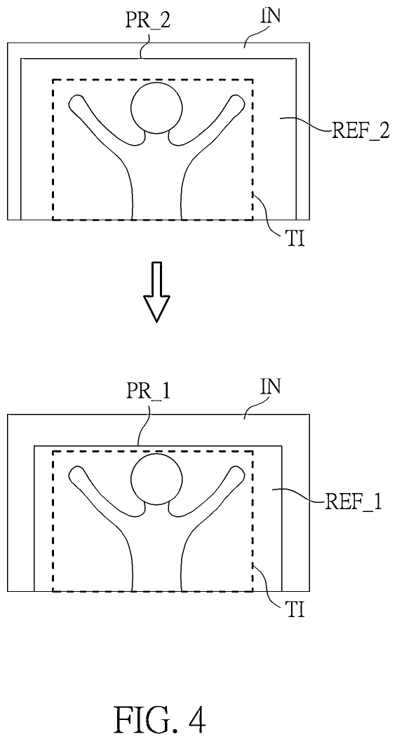

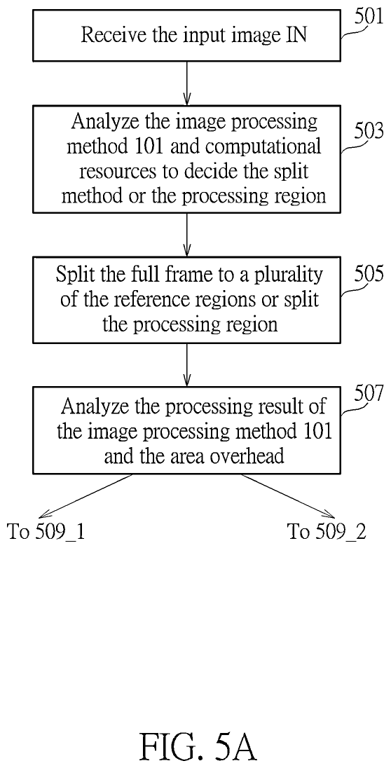

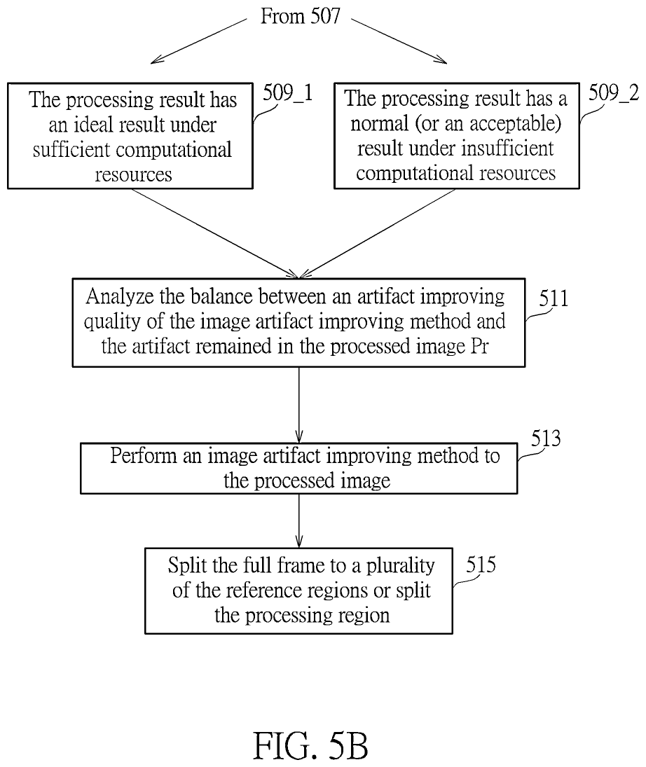

FIG. 5A and FIG. 5B are flow charts illustrating the image processing method, according to one embodiment of the present application. The flow charts in FIG. 5A and FIG. 5B comprise following steps:

Step 501

The image processing device receives the input image IN.

Step 503

Analyze the image processing method 101 and computational resources to decide the defining method (e.g., the embodiments in FIG. 2A, FIG. 2C, and FIG. 3) or the processing region (e.g., the embodiment in FIG. 4).

Step 505

Define the full frame to a plurality of the reference regions or define the processing region.

Step 507

Analyze the processing result of the image processing method 101 and the area overhead.

Step 509_1

The processing result has an ideal result under sufficient computational resources. For example, the processed image P _has an ideal enhancement quality when the image processing method 101 is an image enhancement method.

Step 509_2

The processing result has a normal (or an acceptable) result under insufficient computational resources. For example, the processed image Pr has a normal (or acceptable) enhancement quality when the image processing method 101 is an image enhancement method.

After the step 507, the flow in FIGS. 5A and 5B enters one of the steps 509_1 and 509_2.

Step 511

Analyze the balance between an artifact improving quality of the image artifact improving method and the artifact remained in the processed image Pr.

Step 513

Perform artifact improving to the processed image.

Step 515

Generate the output image.

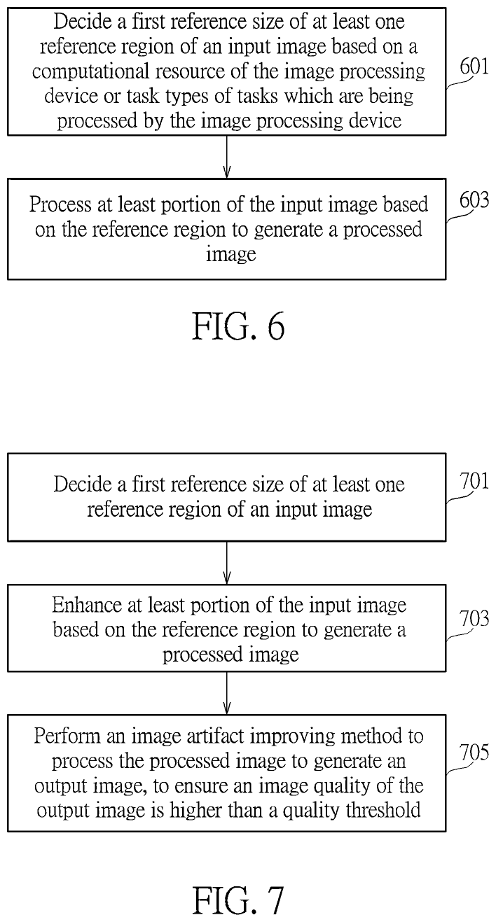

In view of above-mentioned embodiments, an image processing method can be acquired. FIG. 6 is a flow chart illustrating summarized steps of an image processing method according to one embodiment of the present application. FIG. 6 comprises following steps:

Step 601

Decide a first reference size of at least one reference region of an input image based on a computational resource of the image processing device or task types of tasks which are being processed by the image processing device.

Step 603

Process at least portion of the input image based on the reference region to generate a processed image.

As illustrated in FIG. 1A, an image artifact improving method may be performed to process the processed image to generate an output image, to ensure an image quality of the output image is higher than a quality threshold. Also, in one embodiment, the step 603 enhances the at least portion of the input image based on the reference region.

In one embodiment, a second reference size of the reference region is decided before the steps 601 and 603, such as the embodiments illustrated in FIG. 2A, FIG. 2C and FIG. 4. The second reference size is larger than the first reference size. In such case, the step 603 changes the second reference size to the first reference size, to reduce the second reference size to the first reference size based on the computational resource or the task types.

FIG. 7 is a flow chart illustrating summarized steps of an image processing method according to another embodiment of the present application. FIG. 7 comprises following steps:

Step 701

Decide a first reference size of at least one reference region of an input image.

Step 703

Enhance at least portion of the input image based on the reference region to generate a processed image.

Step 705

Perform an image artifact improving method to process the processed image to generate an output image, to ensure an image quality of the output image is higher than a quality threshold.

As above-mentioned, the parameters of the reference regions and the parameters of the image artifact improving method may be set in a balance manner, to ensure a proper output image Out is generated without too much necessary computation.

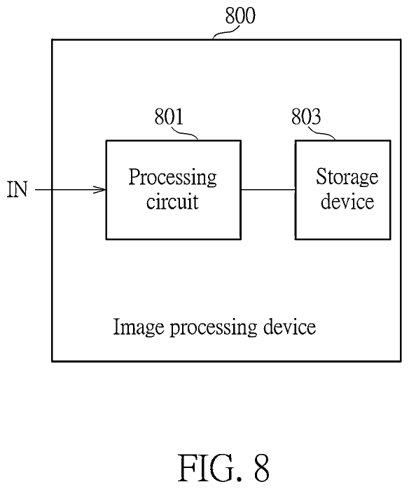

FIG. 8 is a block diagram illustrating an image processing device according to one embodiment of the present application. In the embodiment of FIG. 8, the image processing device 800 comprises a processing system 801 and a storage device 803. The image processing device 800 may be any type of electronic device which can process image, such as a mobile phone, a computer or a camera. The processing system 801 is configured to execute at least one program stored in the storage device 803 to perform above-mentioned methods. The storage device 803 may be provided inside or outside the image processing device 800.

The processing system 801 may be a circuit or a device which has computation abilities, such as a CPU or a GPU. However, the processing system 801 is not limited to be a single circuit or a single device. The functions of the processing system 801 may be provided by a plurality of devices or circuits of the image processing device 800. Also, these devices or circuits may further comprise other functions besides the functions of the processing system 801. Accordingly, the processing system 801 may be regarded as a system comprising at least one circuit or at least one device.

In view of above-mentioned embodiments, the area overhead may be dynamically adjusted corresponding to different requirements. By this way, the image quality of the output image may be remained without increasing too much computation. Also, the usage of the computation resource can be accordingly optimized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, applied to an image processing device, comprising:
(a) deciding a first reference size of at least one reference region of an input image based on a computational resource of the image processing device or task types of tasks which are being processed by the image processing device; and
(b) processing at least portion of the input image based on the reference region to generate a processed image.

2. The image processing method of claim 1, wherein the step (b) further comprises:
improving edge artifacts generated while processing the input image.

3. The image processing method of claim 2, wherein the step (b) enhances the at least portion of the input image based on the reference region.

4. The image processing method of claim 1, further comprising:
defining the input image to a plurality of the reference regions respectively with the first reference size, wherein at least portion of the reference regions are overlapped.

5. The image processing method of claim 1, further comprising:
deciding a processing region comprising a target region of the input image and the reference region; and
processing the target region according to the reference region.

6. The image processing method of claim 1, further comprising:
deciding a second reference size of the reference region before the steps (a) and (b), wherein the second reference size is larger than the first reference size;
wherein the step (a) reduces the second reference size to the first reference size based on the computational resource or the task types.

7. The image processing method of claim 6, further comprising:
defining the input image to a plurality of the reference regions respectively with the second reference size before the steps (a), and (b);
wherein the step (a) defines the input image to a plurality of the reference regions respectively with the first reference size according to the system resources or the task types;
wherein portions of the reference regions are overlapped.

8. The image processing method of claim 1, further comprising:
defining the input image to a first number of the reference regions respectively before the steps (a) and (b);
wherein the step (a) defines the input image to a second number of the reference regions according to the system resources or the task types, wherein the first number is larger than the second number;
wherein portions of the reference regions are overlapped.

9. The image processing method of claim 6, further comprising:
deciding a second processing region comprising a target region of the input image and the reference region with the second reference size before the steps (a) and (b); and
wherein the step (a) decides a first processing region comprising the target region and the reference region with the first reference size, wherein the second processing region is larger than the first processing region.

10. An image processing device, comprising:
a processing system, configured to perform following steps:
(a) deciding a first reference size of at least one reference region of an input image based on a computational resource of the image processing device or task types of tasks which are being processed by the image processing device; and
(b) processing at least portion of the input image based on the reference region to generate a processed image.

11. The image processing device of claim 10, wherein the step (b) further comprises:
improving edge artifacts generated while processing the input image.

12. The image processing device of claim 11, wherein the step (b) enhances the at least portion of the input image based on the reference region.

13. The image processing device of claim 10, wherein the processing system further performs:
defining the input image to a plurality of the reference regions respectively with the first reference size, wherein at least portion of the reference regions are overlapped.

14. The image processing device of claim 10, wherein the processing system further performs:
deciding a processing region comprising a target region of the input image and the reference region; and
processing the target region according to the reference region.

15. The image processing device of claim 10, wherein the processing system further performs:
deciding a second reference size of the reference region before the steps (a) and (b), wherein the second reference size is larger than the first reference size;
wherein the step (a) reduces the second reference size to the first reference size based on the computational resource or the task types.

16. The image processing device of claim 15, wherein the processing system further performs:
defining the input image to a plurality of the reference regions respectively with the second reference size before the steps (a), and (b);
wherein the step (a) defines the input image to a plurality of the reference regions respectively with the first reference size according to the system resources or the task types;
wherein portions of the reference regions are overlapped.

17. The image processing device of claim 10, wherein the processing system further performs:
defining the input image to a first number of the reference regions respectively before the steps (a) and (b);
wherein the step (a) defines the input image to a second number of the reference regions according to the system resources or the task types, wherein the first number is larger than the second number;
wherein portions of the reference regions are overlapped.

18. The image processing device of claim 15, wherein the processing system further performs:
deciding a second processing region comprising a target region of the input image and the reference region with the second reference size before the steps (a) and (b); and
wherein the step (a) decides a first processing region comprising the target region and the reference region with the first reference size, wherein the second processing region is larger than the first processing region.
